(19) United States
(12) Patent Application Publication
(10) Pub. No.: US 2012/0260192 A1
(43) Pub. Date: Oct. 11, 2012

(54) AUTOMATED BROWSER MODE BASED ON USER AND ACCESS POINT

(76) Inventor: Sean D. Detweiler, Concord, MA (US)

(21) Appl. No.: 13/427,410

(22) Filed: Mar. 22, 2012

Related U.S. Application Data
(60) Provisional application No. 61/473,899, filed on Apr. 11, 2011.

(51) Int. Cl. G06F 3/01

(52) U.S. Cl. 715/745

(57) ABSTRACT

A browser system and corresponding method of operation has a personalized browser display mode configured for inter-operation with a cloud-based service. The display mode is automatically selected based on user information (e.g., user login) and a user access point. The system and method enables a browser application operating in conjunction with a cloud-based service to recognize a particular user logged in under a single user login, and automatically select one display mode and or user profile of a plurality of browser display modes or user profiles for that same user and user login based on which access point the user is accessing the browser from, without requiring the user to log in with different user login to effect the same change in browser display.

### RELATED APPLICATIONS

This application claims priority to, and the benefit of, co-pending U.S. Provisional Application No. 61/473,899, filed Apr. 11, 2012, for all subject matter common to both applications. The disclosure of said provisional application is hereby incorporated by reference in its entirety.

### FIELD OF THE INVENTION

The present invention relates to browser implementations working in conjunction with a cloud-based service, and more particularly to the automated selection and implementation of a personalized browser display mode based on the access point of the user.

### BACKGROUND OF THE INVENTION

Conventional web browsers or Internet browsers are software applications utilized for accessing information on the World Wide Web. The browser application makes use of a uniform resource locator (URL) as an address to locations on the World Wide Web that contain information, including web pages, images, video, or other content. Browser applications are first and foremost utilized to access the World Wide Web, but additionally can be used to access information on web servers, private networks, or certain files having compatible file types.

Cloud computing relates to an architecture where typical computer implemented operations are performed at a location distal from, and for the most part unknown to, the user requesting the computer implementation. Computation, data access and storage, and the like, reside on the “cloud” rather than on a local computer or local network.

Some conventional browser applications are configured to work in conjunction with a cloud architecture. In these scenarios, a cloud-based service (e.g., iGoogle™ offered by Google, Inc.) works with a browser application operating on a computer where the user is accessing the browser application. The cloud stores such things as information needed for the browser application to generate a customized view of the browser display, including views of the browser display itself, home page, cookies, bookmarks, search history, passwords, and the like. With such a configuration, a user can have a customized personalized home page that is viewable whenever the user logs into their browser application by providing a user login information. Regardless of which computer the user is using to access the web, if that particular computer has a browser application loaded onto it, the user may start up the browser application, log in, and the user is presented with their same customized personalized home page.

### SUMMARY

There is a need for a browser application capable of working in conjunction with a cloud-based service that will enable the user to have customized personalized browser experience with an automated recognition of the particular access point being utilized by the user when using the browser application. The present invention is directed toward further solutions to address this need, in addition to having other desirable characteristics.

In accordance with one embodiment of the present invention, a computer implemented browser system includes a browser application configured to receive user identifying information for a specified user and corresponding to a single user login. An access point determiner can be configured to identify access point information. A communication mechanism can enable communication between the browser application and a cloud-based service. Two or more personalized browser display modes can be capable of display by the browser application. The cloud-based service, based at least on the user identifying information and the access point information, can instruct the browser application to display a selected one of the two or more personalized browser display modes.

In accordance with aspects of the present invention, the access point information can include device identification information. The access point information can include location information. The access point information can include geolocation information. The access point information can include user-identified mode information. User identifying information can include one or more information components specific to a user. The communication mechanism can include a communication link between a device operating the browser application and a cloud-based service on a world wide web.

In accordance with further aspects of the present invention, the two or more personalized browser display modes can include one or more of a home mode, an office mode, a travel mode, or a user customized mode. The two or more personalized browser display modes can include a predetermined selection and arrangement of bookmark buttons. The two or more personalized browser display modes can include a predetermined selection and arrangement of sub-windows. The two or more personalized browser display modes can include a predetermined selection of user profile. The two or more personalized browser display modes can include a predetermined selection of tabs revealing layered display windows.

In accordance with one embodiment of the present invention, a method of implementing a browser system using a computing device includes initiating a browser application on the device with user specific information. Access point information can be automatically identified. The access point information can be communicated to a remote cloud-based service. The cloud-based service can instruct the browser application to display a selected one of two or more personalized browser display modes based on the user specific information and the access point information. The browser application can display the selected personalized browser display mode on the device.

In accordance with one example embodiment of the present invention, a computer implemented browser system can include a browser application configured to receive user identifying information for a specified user and corresponding to a single user login. An access point determiner can be configured to identify access point information. A communication mechanism can enable communication between the browser application and a cloud-based service. At least two different personalized user profiles can be associated with a user under the same user login. The cloud-based service, based at least on the user identifying information and the access point information, can determine and instruct the browser application to implement a selected one of the at least two different personalized user profiles associated with the user under the same user login.

In accordance with one example embodiment of the present invention, a method of implementing a browser system using a computing device can include initiating a browser application on the device with user specific information. Access point information can be automatically identified. The access point information can be communicated to a remote cloud-based service. The cloud-based service can instruct the browser application to implement a selected one of at least two different personalized user profiles associated with a same user login.

### BRIEF DESCRIPTION OF THE FIGURES

These and other characteristics of the present invention will be more fully understood by reference to the following detailed description in conjunction with the attached drawings, in which:

FIG. 1 is a representation of a conventional browser display and example of a first mode of display according to one aspect of the present invention;

FIG. 2 is a representation of a second mode of browser display, according to one aspect of the present invention;

FIG. 3 is a diagrammatic illustration of a device capable of implementing the present invention;

FIG. 4 is a flowchart representing an example implementation according to one aspect of the present invention; and

FIG. 5 is a diagrammatic illustration of a browser application system, according to one embodiment of the present invention.

### DETAILED DESCRIPTION

An illustrative embodiment of the present invention relates to a browser system having a personalized browser display configured for operation with a cloud-based service the display mode of which is automatically selected based on a user login and a user access point. More specifically, the present invention enables a browser application operating in conjunction with a cloud-based service to recognize a particular user (e.g., via user login information), and when the user is accessing the browser from a specific access point (e.g., device, location, event, and/or time) as compared with the same user with the same login information accessing from a different access point, the browser application adjusts a browser display mode based on the user and the access point to automatically personalize the browser display. This functionality is particularly useful when a user wishes to access their personalized browser display from, for example, a home computer access point and be presented with a first combination of bookmarks, sub-windows, content of sub-windows, and the like, and then separately access their personalized browser display from, for example, a work computer access point, and be presented with a second different combination of bookmarks, sub-windows, content of sub-windows, and the like. The user can indicate a predetermined order of priority or a set of rules for various access point characteristics in such a way that dictates which browser display mode to utilize.

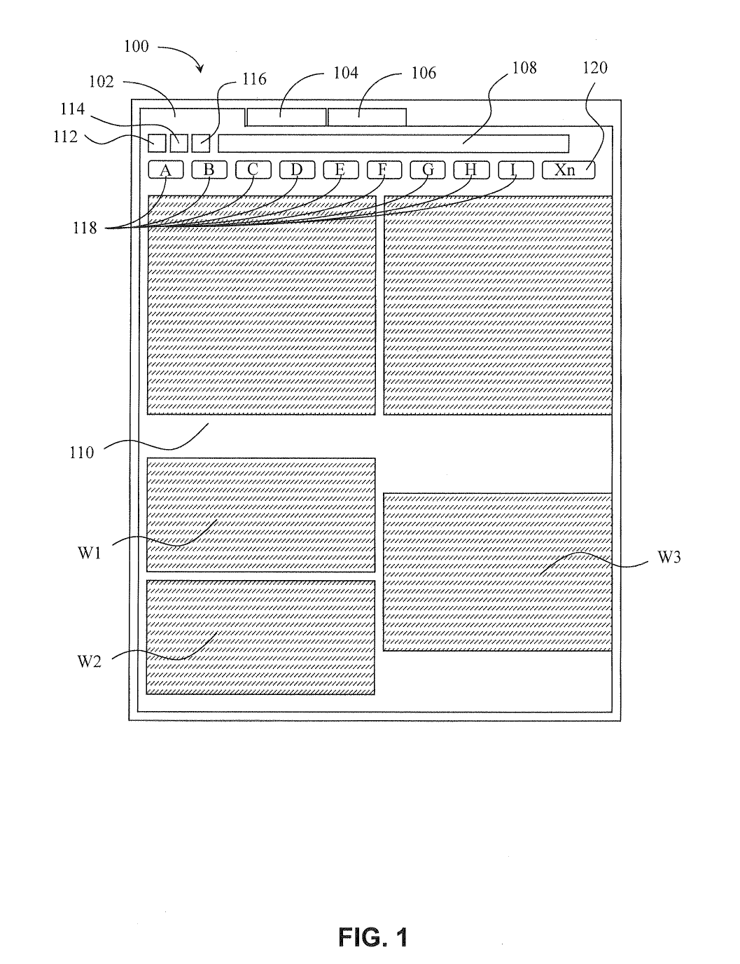

FIGS. 1 through 5, wherein like parts are designated by like reference numerals throughout, illustrate example embodiments of a personalized browser system according to the present invention. Although the present invention will be described with reference to the example embodiments illustrated in the figures, it should be understood that many alternative forms can embody the present invention. One of skill in the art will additionally appreciate different ways to alter the parameters of the embodiments disclosed, such as the size, shape, or type of elements or materials, in a manner still in keeping with the spirit and scope of the present invention.

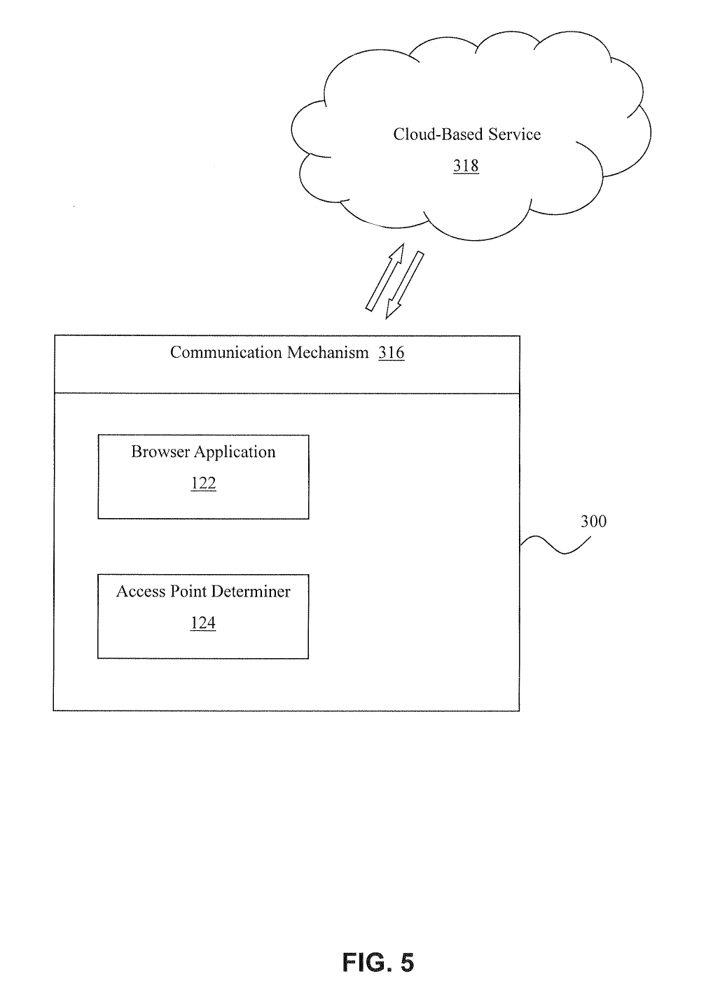

FIG. 1 shows an example conventional browser display 100 of a browser application 122 (see also FIG. 5). The browser display 100 can include a number of different display features, including a tab configuration for selecting a particular active web page, or a sub-tab configuration for selecting a window or sub-window within a page, and/or content of sub-windows. As shown in the example, a first tab 102 has been selected and there are additional tabs (second tab 104 and third tab 106) that are available for selection but are not the active tabs as presently illustrated in the figure. An address field 108 displays the address of a particular active web page or desired display of information, which is displayed in a display area 110. The address field 108 can also serve as an input location in the display for the user to enter a desired address or to implement a search. Additional buttons 112, 114, and 116 can be provided, each with differing functionality such as browse backward, browse forward, refresh, jump to a home page, and the like. Also shown in the example illustration are a plurality of bookmark buttons 118, each individually labeled as A, B, C, D, E, F, G, H, and I. Each bookmark button 118 (A through I) represents a shortcut to a different URL or file location. For purposes of illustration, the buttons have been labeled with the letters A through I, however, one of skill in the art will appreciate that the bookmark buttons 118 are most often able to be labeled by the user as desired. Further conventionally provided is a last bookmark button 120, individually labeled as Xn, which provides access to an additional list of bookmark buttons 118 that do not fit on the page in the space allotted to the plurality of bookmark buttons 118. This last bookmark button 120 is often labeled “additional bookmarks”, or the like. Such a last bookmark button 120 typically exhibits a pull-down menu of address shortcuts to additional URL locations when clicked (i.e., the additional bookmark buttons 118 that exceeded the amount able to be displayed on the page).

One of skill in the art will appreciate that the browser display shown in FIG. 1 is intended to be representative of all known conventional browser displays of known browser applications 122, including but not limited to Google Chrome™ browser provided by Google, Inc., Internet Explorer® browser provided by Microsoft Corporation, Safari®browser provided by Apple, Inc., and Firefox® browser provided by Mozilla Corporation. As such, the illustrative example shown in FIG. 1 is not limiting to the invention. Rather, the particular aspects and features of the invention are intended for equivalent use on all of the aforementioned browser applications, in addition to other equivalent browser applications not specifically mentioned herein. Furthermore, one of skill in the art will appreciate that the term “bookmark” or “bookmark buttons” refers to the functionality whereby a browser display supporting a bookmarking feature lets a user save the address (e.g., a URL) of a web page, or other information, to be easily retrieved, navigated to, or revisited at a later time. The term “bookmark” is intended to mean and be interchangeable with the term “favorite”, which is often used optionally to describe a bookmark or bookmark functionality. Likewise, other implementations for similar buttons within browsers are anticipated by the present description to fall within the confines of the term “bookmark”. As a further example, the use of tabs or drop down tabs (e.g., such as a “Home” tab provided in iGoogle customized browser displays with a drop down arrow revealing other customizable tabs leading to sub-layers or alternate windows of display of a different collection of widgets or gadgets within the iGoogle framework) are representative of the concept of a “bookmark” or “favorite”, in that they lead to pages having a further customized collection of bookmarks, gadgets, or the like. Accordingly, the present invention, though it refers to bookmarks herein, is intended to be equally applicable to bookmarks, favorites, tabs, and the like, interchangeably.

In accordance with the present invention, a computer implemented browser system includes the browser application 122 configured to receive user identifying information for a specified user and corresponding to a single user login. The user identifying information can take numerous forms; however, an example implementation makes use of user login information supplied by the user to the browser application 122. The user login information can be stored for repeated access by the browser application 122 to automatically log-in the user upon startup of the browser application 122, as is known by those of skill in the art.

In the above-mentioned conventional browser applications 122, a user has the option of saving a plurality of bookmark buttons 118 to be displayed across some portion of the browser display 100. Present convention dictates that such bookmark buttons 118 be placed relatively near or in the header or top portion of the browser display 100 as shown in FIG. 1. One shortcoming to such a convention is that only a limited number of bookmark buttons 118 can be displayed across the width of the browser display 100 before there is insufficient space to accommodate further additional bookmark buttons 118. The conventional solution to help the user in dealing with this shortcoming is to provide the last bookmark button 120 (Xn), which as described herein and is typically configured as a shortcut button leading to a list of further bookmark buttons incapable of being displayed on the primary browser display 100 due to the lack of space. This solution is sufficient for many users and many implementations.

However, with the advent of browser applications 122 working in conjunction with cloud-based services 318 (see FIG. 5) the user is now provided with the ability to call up a personalized browser display 100 regardless of their location, access point, or device being utilized to access the browser application 122. Said differently, and as understood by those of skill in the art, it is possible for a user to call up a browser application 122 on a first computer (installing the application first if it is not resident on the first computer), provide login information to that browser application 122, and be provided or presented with a personalized browser display 100 familiar to that user and based on that user's specific login information. The same user can switch to a second computer or similar device, call up the same browser application 122 (again, installing the application on that second device first if it is not resident already), provide the same login information, and be provided or presented with the same personalized browser display 100, even though the user is using a different access point. The browser application 122 makes use of conventionally known communication mechanisms, such as a communication link (see communication mechanism 316 in FIG. 5) between a device operating the browser application 122 and a cloud-based service 318 on a world wide web. The login process effectively communicates user identifying information to the cloud-based service 318 in the form of one or more information components specific to a user (e.g., a user login). The communication mechanisms and login processes are known to those of skill in the art, and are therefore not further discussed herein. A representative example of such a browser application 122 is the Google Chrome browser implementing the iGoogle personalized browser display 100.

Common items displayed on a user's personalized browser display 100 may include sub-windows displaying a personal email account, a display of top news stories matching desired categories by the user, a personal horoscope, an instant messaging application, any number of gadgets or widgets, and the like. As such, the user may be inclined to want fast access to their personalized browser display at all times whenever they are using a computer or similar device capable of supporting a personalized browser display 100, regardless of whether the user is at home, at work, traveling, or the like.

While such ability for a user to call up the same personalized browser display 100 regardless of their location or the device they are using (so long as the browser application 122 is installed on that device) has been well received and desired, the present invention identifies an unfortunate shortcoming to such functionality, and provides a solution to overcome this shortcoming.

The shortcoming is that when a user is accessing their personalized browser display 100 using their login information from a first access point, the user may typically prefer to have a first browser display configuration; whereas, when the same user is accessing their personalized browser display 100 using their same login information but from a second access point, the user may typically prefer to have a second browser display configuration.

For example, when the user accesses their personalized browser display 100 from a first access point, the user may use a first subset of bookmark buttons 118 more frequently; whereas, when the same user is accessing their personalized browser display 100 using their login information from a second access point, the user may typically prefer to use a second subset of bookmark buttons 118 more frequently. The misalignment of the particular bookmark buttons 118 displayed with the contemporaneous interests of the user at the time, location, event, or other influential characteristic at which they are accessing their personalized browser display 100 can be very frustrating and/or distracting. Likewise, to the extent the user makes use of a personalized collection of sub-windows presenting content of gadgets, widgets, or the like, (e.g., such as can be accessed by any number of buttons, tabs, sub-tabs, pull-down menus, or the like) such sub-windows (e.g., sub-window W1, sub-window W2, and sub-window W3 in FIG. 1) may be particularly suited to use on the first first access point and a different set of sub-windows may be preferred for use on the second second access point. Further likewise, to the extent the user makes use of other personalization features that are tied to the user's personal profile and work in conjunction with the cloud-based service 318, the user may prefer to configure aspects of their personal profile in a manner consistent with their particular access point at the time they are logged into their personalized browser display 100. Such configuration aspects can be automatically recognized and implemented in accordance with the teachings of the present invention. An example implementation may include interaction with a feature that tracks personal preferences indicated by the user as they operate their browser application 122. The user may have personal preferences of a particular nature or characteristic when operating the browser application 122 from a first access point (e.g., home) verses when the user is operating the browser application 122 from a second access point (e.g., office), without requiring the user to login and maintain multiple different usernames and passwords. To provide further clarity, but in no way limiting the scope of the present invention, the above-described shortcoming will be further illustrated with examples below.

Specifically, assuming the user is at home, the user logs into the browser application 122 on their home computer, and the user is provided or presented with their personalized browser display 100 with the layout of bookmark buttons 118 as shown in FIG. 1. The user is content with this particular layout of bookmark buttons 118, because the user is provided with the ability to order the bookmark buttons 118 as they wish. So, for example, bookmark button 118 A may be a shortcut to the area weather. Bookmark button 118 B may be a shortcut to the local movie theater where the current list of movies is posted. Bookmark button 118 C may be a shortcut to the local television listings. Bookmark button 118 D may be a shortcut to the user's social networking account (e.g., Facebook®). Bookmark button 118 E may be a shortcut to an mp3 purchasing website (e.g., Napster®). Bookmark button 118 F may be a shortcut to a shopping website (e.g., Amazon.com®). Bookmark button 118 G may be a shortcut to a local real estate listing website that the user periodically visits to search for a new house to purchase. Bookmark button 118 H may be a shortcut to the user's personal online bank. Bookmark button I may be a shortcut to a local newspaper website for the user's home town newspaper. Further provided in the browser display 100 are sub-windows presenting content of gadgets, widgets, or the like, such as sub-window W1, which may be a display of an RSS feed for a local hometown newspaper; sub-window W2, which may be a display of the user's personal stock portfolio; and sub-window W3, which may be a display of the user's personal email.

With the above-identified shortcuts to the user's plurality of bookmark buttons 118, the user has run out of space on their personalized browser display 100 to place any additional bookmark buttons 118. As such, additional bookmark buttons 118 on the user's bookmark list will be hidden behind the last bookmark button 120 Xn. For example, not shown in FIG. 1 (because they are hidden behind or under, and accessed through, the last bookmark button 120 Xn), the user may have an additional collection of bookmark buttons 118. In this additional collection there may be a bookmark button 118 J that may be a shortcut to the main web page for the user's employer. Bookmark button 118 K may be a shortcut to the user's online employee directory at their employer. Bookmark button 118 L may be a shortcut to the United States Patent & Trademark Office main web page, which the user references frequently throughout their work day. Bookmark button 118 M may be a shortcut to the Google Patents™ URL, which the user references in the course of performing their job. Bookmark button 118 N may be a shortcut to the United States Patent & Trademark office trademark searching start page, which the user references in the course of performing their job. Bookmark button 118 O may be a shortcut to a business networking website (e.g., LinkedIn®). Bookmark button 118 P may be a shortcut to a traffic report website that enables the user to monitor traffic problems and map out the most efficient route home during commuting times.

Upon review of the list of bookmark buttons 118 (A through I) described above and displayed in FIG. 1, such illustrative examples are intended to represent a collection of bookmark buttons 118 with shortcuts to website locations that the user would most often utilize when they are at home (or at least not at “the office” or not working). In fact, the list of bookmark buttons 118 A through I may be considered by many to be distractions at the office or when working. If the user were to be logged in to their personalized browser display 100 at the office, their browser display 100 (prior to implementation of the present invention) would show all of the aforementioned bookmark buttons 118 A through I. In this illustrative example, virtually none of the shortcut destinations that result from bookmark buttons 118 A through I are needed at the user's work location as they are non-work related shortcuts. The user when at the office or working would, of course, make more preferable and productive use of bookmark buttons J through P as characterized above, which are more closely related to their work activities.

With the implementation of the present invention, the user is provided with their personalized browser display 100 automatically updated or re-configured based on their access point (e.g., device, location, time, event, and/or the like) to display to the user a preferred configuration of the personalized browser display 100. The particular access point can be taken into account in accordance with the present invention, as will be further discussed herein. As utilized herein, the phrase “access point” refers to an actual hardware device (e.g., computer, tablet, mobile device, or the like) the user is using to access the browser display 100, and/or the actual location of the device the user is using to access the browser display 100, whether the location has a positional characteristic (e.g., geographic location), or a task based contextual location (e.g., office, home, travel, and the like), or other influential characteristic such as time of day (e.g., during typical work hours vs. during early morning or late evening hours), or event (e.g., while the user is in motion vs. being in a stationary location, or while the device is being actively used vs. sitting idle, or any form of event that can relate to the user and their device(s)). whether with the same hardware device or a different hardware device. As such, “access point” is intended to refer to a characteristic of device, location (including positional, task, time, or event), use, or other triggers, and/or combinations thereof, relative to the user implementing a browser application 122 as described herein.

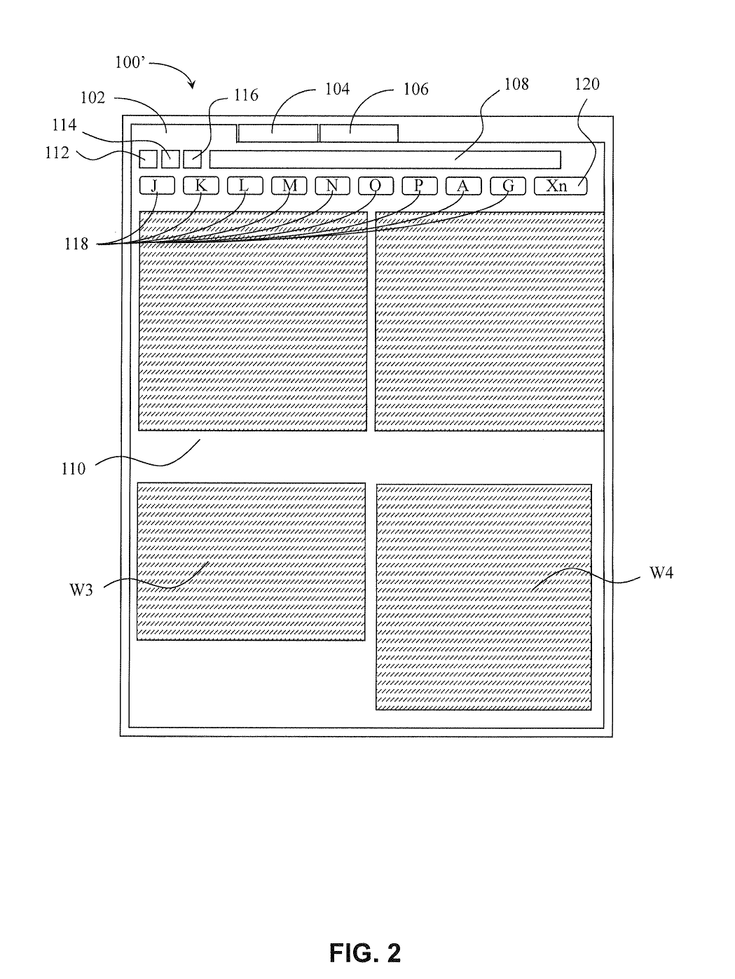

Returning to the illustrative example, and turning to FIG. 2, a browser display 100′ generated by the browser application 122 shows items more suitable and useful when the user is accessing the web from their work or office location. Thus, with the addition of browser display 100′, there are now two “modes” of browser display available to the user, and personalized by and for the user. The first browser display 100 is more useful in a home scenario or mode, and the second browser display 100′ is more useful in a work/office scenario or mode. More specifically, the browser display 100′ now shows bookmark button 118 J, a shortcut to the main web page for the user's employer; bookmark button 118 K, a shortcut to the user's online employee directory at their employer; bookmark button 118 L, a shortcut to the United States Patent & Trademark Office main web page; bookmark button) 118 M, a shortcut to the Google Patents™ URL; bookmark button 118 N, a shortcut to the United States Patent & Trademark office trademark searching start page; bookmark button 118 O a shortcut to a business networking website (e.g., LinkedIn®); and bookmark button 118 P, a shortcut to a traffic report website that enables the user to monitor traffic problems and map out the most efficient route home during commuting times. In addition, bookmark button A, a shortcut to the area weather, as well as bookmark button G, a shortcut to a local real estate listing website that the user periodically visits to search for a new house to purchase, which may occasionally need to be accessed during workday hours, are also shown in the browser display 100′. Further provided in the browser display 100′ are sub-windows presenting content of gadgets, widgets, or the like, such as sub-window W4, which may be a display of an RSS feed for a work-related professional blog; and sub-window W3, which may be a display of the user's personal email as shown in FIG. 1. Note, additionally, that the arrangement of the sub-windows has changed between the browser display 100 in the “home” configuration or mode and the browser display 100′ in the “work” configuration or mode, and specifically that the same sub-window W3 has changed positions on the page. Such different widget, gadget, or other sub-window content and/or arrangements could be further organized by a tab system, each tab being selectable by the user to reveal the page or display containing the desired collection of sub-windows and content. In such an implementation, the present invention can merely indicate or select the desired “tab” containing the desired sub-windows and content, as would be appreciated by those of skill in the art.

The above description shows two possible variations of preferred configurations for the user's personalized browser display 100 and 100′ as might be utilized in a “home” environment verses an “office” or “work” environment (the terms “office” and “work” being interchangeable herein, and intending to communicate the place or time where a user is working verses when they are on personal time). One difference between the two browser displays 100, 100′ is the positional arrangement of the bookmark buttons 118 A through P, and the positional arrangement and selection of the sub-windows W1 through W 4 presenting gadgets, widgets, or the like. The positional arrangement of the bookmark buttons 118 A through P is primarily defined by the buttons being arranged in a different order from left to right on the particular display. By changing the order of the bookmark) buttons 118 A through P, a different combination or selection of buttons are persistently shown on the browser display 100, 100′, and a different combination or selection of buttons are forced into hiding and being accessed by the last bookmark button 120 Xn. As such, one is able to change the personalized browser display 100, 100′ to be more suitable for a desired use or situation. Said differently, if a user were to be primarily accessing their browser display from a single access point all the time, they may be content with the simple ability provided prior to this invention to set bookmark buttons 118 and sub-windows (e.g., W1 through W4) in a particular order or configuration and not frequently revisit that order or configuration. However, if that user were to frequently access their browser display from different access points, and the user is primarily focused on different tasks (e.g., home vs. work vs. travel vs. productivity vs. entertainment), then the frustration and/or distraction described in the background section of the present application may be experienced by the user, but for the implementation of the present invention as further described herein.

More specifically, the present invention leverages the ability of a user to personalize the arrangement and configuration of their browser applications 122 working in conjunction with cloud-based services 318, to re-configure or rearrange their browser display, such as shown by example herein between at least browser display 100 and browser display 100′, to result in the automatic presentation of a browser display 100, 100′ mode that is more appropriate or more desired by the user for their particular access point without having to maintain different accounts or logins. It should be noted that solely for illustrative purposes herein only two browser display 100, 100′ arrangements/configurations/modes are illustrated in the figures. However, the present invention is by no means limited to only two instances. Rather, as one of skill in the art would appreciate, a plurality of different browser display modes or instances 100, 100′, . . . 100ⁿ can be implemented in accordance with the present invention.

Furthermore, as utilized herein, a “device” refers to any type of hardware or software, including by way of example, a laptop, desktop, or notebook computer, a hand-held computer, a mobile computer, phone or smart-phone, a tablet computer, a portable transceiver, a set-top box (e.g. for internet TV), implementation of software applications to implement or mimic any such hardware on other hardware, and any computing device as would be generally understood by those of skill in the art, which typically would include a processor, a display, and user input capabilities. The present invention is by no means limited to a particular device, and is anticipated for use on all such devices presently known or conceived of in the future to the extent they may be configurable with the appropriate hardware components and be capable of operating a browser display consistent with the present invention and in a manner enabling the operation of the present invention.

One of skill in the art will appreciate that a user must access their browser display 100. 100′ through some such type of device. One of skill in the art will further appreciate that there are many ways for software applications, including browser display applications working in conjunction with cloud-based services 318, to identify a particular device and/or recognize a particular device if desired. For example, a device may be identified or recognized because it maintains a persistent IP address that never changes, including a MAC address (although it is acknowledged there may be privacy and/or security issues surrounding the conveyance of MAC address information to a browser and accessible by a cloud-based service 318). Alternatively, the device may be identified or recognized by an affirmative placement of a persistent cookie saved in the memory of the device that can be requested each time the browser application 122 is launched. The persistent cookie can convey to the browser application 122 and then the cloud-based service 318 an identifier for the particular device being used by the user. Alternatively, mechanisms such as Active X controls, small program building blocks, or Java applets, can serve to create distributed applications that work over the Internet through the browser display 100, 100′ application. These mechanisms can be installed on the user's particular device (likely through a prompt from the browser application 122), and the mechanisms can seek out information on the particular hardware device for later and recurring identification or recognition. Further alternatively, these mechanisms can be utilized to create a random number identity code for a particular device (with no actual user information attached therewith so as to avoid privacy issues), and that random number identity code could be stored by that device for the browser application 122 to access and pass to the cloud-based service 318 upon execution of the browser application 122. One of skill in the art will appreciate there are many different ways for a particular device to be identified and/or recognized on a recurring basis by a browser application 122 and a cloud-based service 318 working in conjunction therewith, such that each time the user uses a particular device, the browser application 122 working in) conjunction with the cloud-based service 318 can readily identify the device and pass that information to the cloud-based service 318 to say, effectively, “this browser is being run on this particular device at this time.” These methodologies and tools are known by those of skill in the art, and therefore further implementation details are not provided herein, as they would simply be restating that which is available in the art. All such tools for device identification as described herein, and any equivalents not specifically described herein, will be further referred to herein as device identification tools, collectively.

In addition, one of skill in the art will further appreciate that whenever a device logs onto the Internet in present day, there may be attempts (whether automated or intentionally initiated) at geolocation of that device. Specifically, the term “geolocation” refers to the process of identifying a geographical location, i.e. country, region, city, latitude, longitude, postal ZIP code, time zone, connection speed, ISP and domain name, IDD country code, telephone area code, nearby weather station code and name, GPS or similar location technologies, and/or mobile carrier or Internet provider information using a proprietary IP address lookup database and technology without invading the Internet user's privacy. When a user logs onto the Internet, and for example, performs a search for “restaurant”, certain search engines and browser application 122s may make use of geolocation services to identify where the user is when they are conducting that search, and then influence the results of that search to show restaurants that are geographically nearby to the location of that device (and therefore the user) at the time of the search. One example geolocation service is the GeolocationAPI provided in HTML5. Such geolocation services are known and understood by those of skill in the art and will therefore not require further explanation here as such details would simply be restating that which is available in the art. All such tools known to provide geolocation as described herein, and their equivalents not specifically described, will be further referred to herein as “location identification tools”, collectively.

The present invention is anticipated for use with all such device identification tools and location identification tools (collectively, “identification tools”) as described above for both identification of device and/or identification of geolocation as they presently are provided and may be provided or modified in the future. The access point information can include device identification information, location information, geolocation information, user-identified mode information, or the like.

Turning again to the present invention, the browser application system implementing the present invention can make use of at least one of the above identification methodologies (e.g., location identification tools) to identify an access point (e.g., device and/or location) automatically, and then automatically select and implement a preferred browser display mode (e.g., browser display 100, 100′, 100ⁿ, or the like) based on the access point and configuration preferences set by the user.

More specifically, the present invention can be implemented as follows. The user can define, through options in the browser application 122, which browser display (e.g., browser display 100, 100′, 100′, or the like) the user prefers to automatically display for which access point scenario (e.g., which mode of browser display is appropriate for a given access point). For example, the user may create an association between the user's home computer and a preference for the browser application 122 to display the browser display 100 of FIG. 1, which in the above example had more non-work related bookmark buttons 118 and sub-windows W1-W3. The user may create this association between the user's home computer and browser display 100 by providing either a device identification tool or indication relating to the user's home computer, or a location identification tool or indication relating to the location of the user's home computer or home, and associating that identification tool information with a particular mode of browser display (in this instance, the mode might be labeled “home”). This information is entered into a “settings”, “options”, or “preferences” screen for the browser application 122 for the application to reference at start-up/login. From such time forward, each time the user executes the browser application 122 on their home computer, the browser application 122 checks the access point information (i.e., the access point device, the access point location, or both), and conveys that information to the cloud-based service 318. The cloud-based service 318 then instructs the browser application 122 to implement the personalized browser display 100, corresponding with the user's home mode configuration.

At a different time, the user may be at their work/office location. Once the user has installed the browser application 122 on their work computer, and gone through a similar setup process whereby they provide either a device identification tool relating to the user's work computer, or a location identification tool relating to the geographical location of the user's work/office computer or location, they will be ready for future automated implementation of their personalized browser display. When the user starts-up and logs into their browser application 122 at work, the browser application 122 uses an access point determiner 124 (see FIG. 5) to check the access point information (i.e., the access point device, the access point location, or both), and conveys that information to the cloud-based service 318. The cloud-based service 318 instructs the browser application 122 to display the browser display 100′ of FIG. 2 (in this instance, the mode might be labeled “work”), which based on the above example contains more work-related or work-appropriate bookmark buttons 118 and sub-windows W3, W4. Similar processes can occur for any browser displays (e.g., browser display 100, 100′, 100ⁿ, or the like).

The browser application 122 can further provide the option of assigning different levels of priority in the determination of access point. For example, the user may indicate as described above the home mode while at their home location and the work mode while at the work location, but additionally indicate a time-based rule that even if the user is at their work location, if it is after 8 PM at night the home mode is displayed instead of the work mode. Various different forms of priority and rule logic for determination of access point can be provided in the options or settings of the browser application 122 as would be readily understood by those of skill in the art. As there are too many different possible combinations to describe herein, all such combinations as would be reasonably expected based on the teaching of the present disclosure are anticipated by, and considered to form aspects of, the present invention.

With regard to the example implementation of the bookmark buttons 118, the following additional detail is provided. The bookmark buttons 118 are saved in different locations or formats depending on the particular browser application 122. However, most browser applications 122 have existing methodologies for importing or exporting bookmark information, or otherwise synchronizing such bookmark information. Specifically, conventional browser applications 122 can export their bookmark information into an HTML file. That file can be imported into other browser applications 122. In accordance with the present invention, when the bookmark buttons 118 displayed on the browser display 100, 100′ are initially set or are modified, the browser application 122 can automatically forward this information in the form of an HTML file to the cloud-based service 318 for the cloud-based service 318 to store with an indication as to the access point and the particular instance of the browser display 100, 100′ being implemented at the time. As such, an association can be created between the HTML file with the order of bookmark buttons 118, and the particular instance of the browser display (e.g., browser display 100, 100′, 100ⁿ, or the like, relating to e.g., home, office, travel, etc.). When the user logs into their personalized browser display the next time, the browser application 122 can be instructed to import its bookmark buttons 118 from the cloud-based service 318. Alternatively, the cloud-based service 318 can be configured to push its HTML document with the correct order of bookmark buttons 118 to the device being utilized for the browser application 122 to access and update locally. The importing or exporting of bookmark information can be implemented upon execution of the browser application 122, can be implemented following a predetermined delay (thus, starting up with the bookmark information from the last time the browser application 122 was launched, and then updating that listing after the browser application 122 is already in operation), or can be manually implemented by the user requesting the process to occur (e.g., with a menu selection, or a button click). An alternative way to handle the bookmark information is to have the bookmark information saved with the cloud-based service. For example, Google Chrome™ browser offers a service where bookmarks can be synchronized across multiple computers. The browser settings, including the bookmarks, are saved in the user's Google or iGoogle™ account. When the user enables the sync feature on their computing device, the Google Chrome™ browser settings on that computing device are saved in the cloud-based Google user account. When the sync feature is enabled on another computing device by signing in to the same user based Google account, the Google Chrome™ browsing application copies the settings that the user has selected to sync from the cloud-based service down to the new computing device.

The above-described processes are merely example implementations of methodologies for the present invention, and are by no means intended to be limiting. One of skill in the art will appreciate that there are other methodologies for importing, exporting, and/or sharing or synchronizing bookmark button information using other mechanisms between a device and a cloud-based service 318, to influence the display of the browser application 122 on the device.

One of skill in the art will further appreciate, that any configurations of the browser display (e.g., browser display 100, 100′, 100ⁿ, or the like) can be stored on the user's device and/or with the cloud based service 318, and a synchronization methodology for sharing information concerning browser display (e.g., browser display 100, 100′, 100ⁿ, or the like) settings, such as described above with the Google Chrome™ browser synchronization of browser settings, can be utilized in conjunction with the teachings of the present invention. For example, with regard to the example sub-windows (e.g., as implemented in services such as iGoogle™), the information concerning which widgets, gadgets, or other content to include, and their layout, is most often already stored in the cloud. As such the cloud-based service 318 can readily push the information to the device based on the access point determination as describe herein. As such, further detail on the sharing and communication of this information, which is readily understood by those of skill in the art, is not necessary, and will not be further discussed herein. Other equivalent services provided with other browser applications, can likewise be utilized in conjunction with the teachings of the present invention in a similar manner.

As one of skill in the art will appreciate, the specific browser display 100, 100′ correlation to the home or office of the illustrative example is by no means limiting to the present invention. The browser display 100 or 100′ may differ between home and office, and/or home or office modes. Furthermore, there may be additional browser display configurations or modes (e.g., browser display 100, 100′, 100ⁿ, or the like), such as a third option for when the user is traveling (which would present a browser display personalized by the user in a manner that is appropriate for traveling, such as including flight tracking websites, hotel reservation websites, mapping websites, and the like), a fourth option for when the user is on vacation, a fifth option for when the user is at one particular office location verses a different office location (e.g., such as when they are at a Massachusetts office verses a California office), a time constraint, an event constrain, and the like, up to a number of options that would be preferably limited by the provider of the browser application 122 or of the cloud-based services 318.

One of skill in the art will additionally appreciate that the user may use the same device, e.g., a tablet computer, when they are at home, at work, or traveling. As such, if the user prefers to have different personalized browser displays even though they are using the same device, the user can create an access point identification by using one of the location identification tools to influence the selection of mode for the browser display. More specifically, the user can configure the settings/options/preferences of their browser application 122 to base the access point determination on the geographical location using a location identification tool. Accordingly, if the user starts-up/logs-on to their tablet computing device when they are at home, the browser application 122 determines (using an access point determiner 124) the access point to be “home” based on the instruction to look at geographical location, and presents the browser display 100 of the ongoing example (e.g., home mode), with the home-appropriate bookmarks and sub-windows. If the user then goes into the office for the day and brings the same tablet computer along, they may later access the same browser application 122 with the same start-up/login information or process. The browser application 122 again looks to determine the access point, and despite the user using the same device, the browser application 122 communicates to the cloud-based service 318 that the user is now at the office and would prefer the browser display 100′ of FIG. 2 (e.g., work/office mode) in the ongoing example, which has more work-appropriate bookmark buttons 118 and sub-windows W3, W4. Again, the priority logic of which browser display to implement can be set by the user in an options or settings menu, as previously discussed herein.

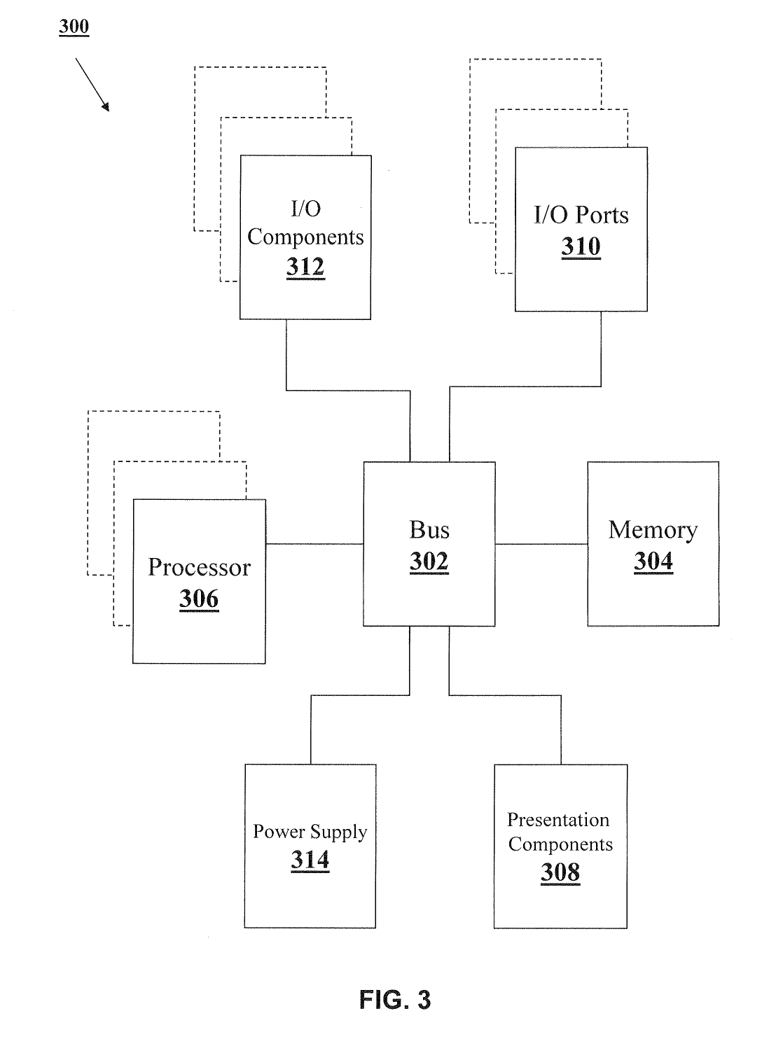

As previously mentioned herein, the term “device” and/or “computing device” as utilized herein refers to any type of hardware or software, including by way of example, a laptop, desktop, or notebook computer, a hand-held computer, a mobile computer, phone or smart-phone, a tablet computer, a portable transceiver, a set-top box (e.g. for Internet TV), implementation of software applications to implement or mimic any such hardware on other hardware, and any computing device as would be generally understood by those of skill in the art, which typically would include a processor, a display, and user input capabilities. With regard to an illustrative example of a “computing device”, FIG. 3 illustrates a computer or computing device 300, within an exemplary operating environment for implementing illustrative methods, systems, and a computer-readable storage medium holding instructions, of the present invention (see also FIG. 5). The computing device 300 is merely an illustrative example of a suitable computing environment and in no way limits the scope of the present invention, as would be understood by those of skill in the art.

The computing device 300, can include a bus 302 that can be coupled the following illustrative components, directly or indirectly: a memory 304, one or more processors 306, one or more presentation components 308, input/output ports 310, input/output components 312, and a power supply 314. One of skill in the art will appreciate that bus 302 can include one or more busses, such as an address bus, a data bus, or any combination thereof. One of skill in the art will appreciate that in some instances, multiple of these components can be implemented by a single device. Similarly, any single component can be implemented by multiple devices. As such, FIG. 3 is merely illustrative of an exemplary computing device that can be used to implement one or more embodiments of the present invention.

The computing device 300 can include or interact with a variety of computer-readable media. For example, computer-readable media can comprises Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices that can be used to encode information and can be accessed by the computing device 300.

The memory 304 can include computer-storage media in the form of volatile and/or nonvolatile memory. The memory may be removable, non-removable, or any combination thereof. Exemplary hardware devices are devices such as hard drives, solid-state memory, optical-disc drives, and the like. The computing device 300 can include one or more processors that read data from components such as a memory 304, various I/O components 312, etc. Presentation component(s) 308 present data indications to a user or other device. Exemplary presentation components include a display device, speaker, printing component, vibrating component, etc.

I/O ports 310 can allow the computing device 300 to be logically coupled to other devices, such as I/O components 312. Some of the I/O components can be built into the computing device 300. Examples of such I/O components include a microphone, joystick, recording device, game pad, satellite dish, scanner, printer, wireless device, networking device, streaming device, touch pad, touchscreen, and the like. Certain of these components (e.g., wireless device, networking device) can form embodiments of communication mechanisms 316 to enable communication between the browser application 122 and a cloud-based service 318 (see FIG. 5).

It should be noted that the access point determiner 124 (see FIG. 5) is mentioned herein in accordance with the implementation of the present invention to identify the access point. The access point determiner 124 can take many forms as would be appreciated by those of skill in the art. The access point determiner 124 can be a separate component operating within or in communication with the computing device 300 being accessed by the user when operating the browser application 122. The access point determiner 124 can further be a component of the browser application 122. The access point determiner 124 is generally directed to carrying out the process described herein whereby the access point is determined using any of the identification tools described (e.g., device identification tools, location identification tools, and/or both). The access point determiner 124 uses the identification tools to determine the access point and then the browser application 122 uses the access point information for communication with the cloud-based service 318 to implement the present invention as described throughout herein.

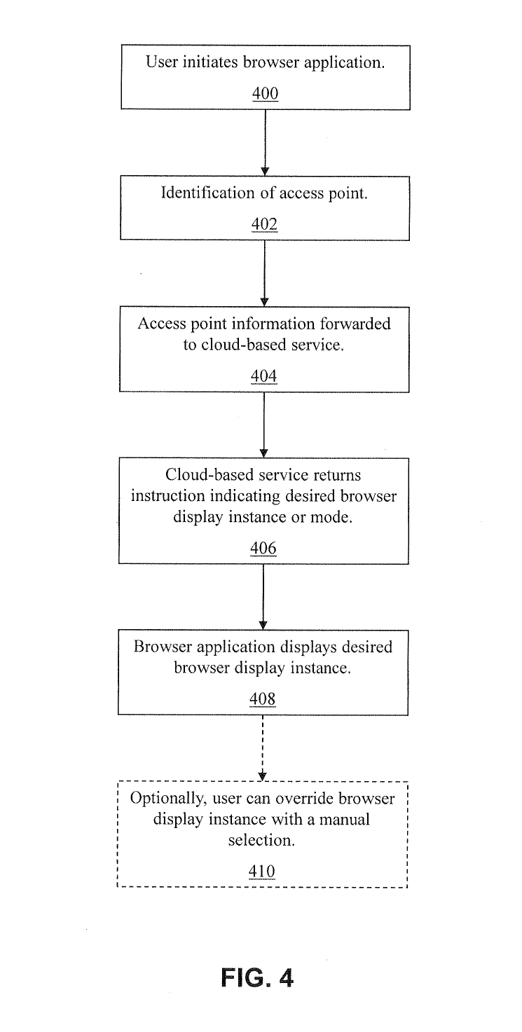

Turning back to the present invention, FIG. 4 illustrates an example methodology for automatic implementation of the inventive process. A user initiates their browser application 122 on their device (step 400), and either manually logs into their cloud-based account or the browser is configured to automatically log into the user's cloud-based account. The browser application 122, using one or more identification tools via the access point determiner 124, automatically identifies the access point (step 402). The browser application 122 forwards the access point information to the cloud-based service 318 (step 404). The cloud-based service 318 returns an instruction correlating to which instance or mode of personalized browser display should be displayed by the browser application 122 based at least in part on the access point determination (step 406). The browser application 122 displays the appropriate or desired instance of browser display to the user (step 408). Optionally, the user can override the browser display instance or mode with a manual indicator of “mode” or selection of browser display, if desired (step 410). Likewise, as previously mentioned, the browser application 122 can be allowed to startup and display the display based on the configuration of the last time the browser application 122 was used, and then perform the communication with the cloud-based service to update the browser display (e.g., browser display 100, 100′, 100ⁿ, or the like) and present the appropriate mode. The mode can be, e.g., home, office, travel, or the like. The mode may further take the form of different custom modes designed and personalized by the user to fit a desired purpose related to the access point. Two or more personalized browser display modes are capable of display by the browser application 122. The cloud-based service 318, based at least on the user identifying information and the access point information, instructs the browser application 122 to display one of the two or more personalized browser display modes in accordance with the present invention. Furthermore, as discussed herein, the user can subsequently override the automated selection of mode and personalized browser display 100, 100′ with a different mode. For example, even if the user is at home, using their home computer, such that their access point is defined either by device or location as “home”, the user may be working from home for a brief period of time and desire to have their office mode of browser display. As such, the user can override the automated selection of browser display 100, which according to the example embodiment described supra, by manually selecting the work/office mode of browser display 100′, if desired. A label of which mode is operating at any particular moment can be displayed to the user for convenience.

The correlation of the user identification information (e.g., user login provided to the cloud-based service 318 to instantiate a particular personalized browser display), with the access point information as provided herein enables the modification of other cloud-based services 318 to generate different mode instances thereof. For example, Google, Inc. has introduced the “Google +1” button for use with web searching. Specifically, the +1 button is a virtual switch that a user can select in a list of search results to indicate that the user “likes” or “recommends” whatever is summarized in the search result link. As a user clicks on “+1” to publicly indicate their stamp of approval, other friends, contacts, and others on the web that are in the user's network can see that the user clicked on “+1” to recommend the subject of the particular search result link, and then give that particular link more attention since it was noted by their friend, contact, etc. However, a particular user may have hobbies or interests that they do not wish to share with their professional co-workers for privacy, or other, reasons. Therefore, to the extent there is overlap in the user's network of people between the user's non-work life and professional work life, the user may prefer to have different modes of their personal profile, again, without requiring the user to maintain different login and password information for each profile. Furthermore, the user may prefer to have their “+1” recommendations be seen publicly only with reference to their particular mode and a corresponding sub-list of contacts.

More specifically, the present invention enables the user to use the same login information to access their iGoogle™ web browser display, but be presented with different modes of such browser display based on the combination of their login information with their access point information at login. Thus, assuming the user is at their home access point, a home mode of the iGoogle™ cloud-based service browser display will be launched, for example on their tablet computer. The user can do an Internet search and indicate a “+1” recommendation for a website that has good information on how to treat a particular chronic medical condition. However, the user may not wish for their co-workers to see such a “+1” public recommendation, because perhaps the user wishes to keep their particular medical condition private. The present invention enables the user to indicate a first network of contacts to have access to that public recommendation posting that are tied to the user's “home” mode of browser display, and therefore a “home” mode of user profile. The user may then travel to work and bring their tablet with them to the office. While at work, the user may launch their browser application 122 again, but this time based on the different access point information the user is presented with their work mode of browser display because the cloud-based service 318 (e.g., iGoogle™) knows the user is at the office. The user can do a work related Internet search on a particular work related issue, find a link that is very useful, and indicate a “+1” recommendation. The user's professional network of contacts may find that recommendation useful. However, the user's private network of friends would have no desire to see this particular “+1” recommendation. As such, given that the user has entered this recommendation from their work mode of browser display, the cloud-based service 318 will only publicly tie their recommendation to the group of professional contacts the user has indicated for their work mode or profile. This means that the user's private friends network cannot see this public recommendation. Likewise, and perhaps more importantly to the user, the user's professional network of contacts from work will not have access to or be able to see the recommendation from the user's private “home” mode of browser display regarding the link to the medical condition. The present invention enables the creation of different modes of browser display, and likewise different corresponding online profiles saved and tracked by the cloud-based service 318, which automatically configure based on access point, to recognize that the user, though they have the same name, login information, and password, may have different aspects and facets of their lives (e.g., figuratively speaking a user may wear many hats), despite in some instances maybe even using the same portable tablet device and login information to access their same browser display tied to their same cloud-based service.

Still a further example implementation of the present invention acknowledges that some users may make use of the same cloud-based email service but have two different accounts, one for personal use and one for work. Furthermore, that user may carry the same device with them between home and the office, and perhaps even while traveling, as described previously herein. With the teachings of the present invention, the user can log into their browser application 122 and communicate with their cloud-based service 318 (such as, e.g., iGoogle™). The user can then indicate a sub-window on their home browser display web page that shows their email. If the access point indicates the user is at home, then the email sub-window displayed can show the user's personal email account. If the user later takes their tablet to work and launches their browser application 122 again, the user can be presented with their work/office browser display web page with the sub-window showing the user's work email account but not their personal email account. The different browser displays as described herein are automatically determined and presented with the communication between the browser application 122 and the cloud-based service 318 factoring in the access point information as described herein.

As referred to earlier herein, FIG. 5 is a diagrammatic illustration of a browser application system according to the present invention. The system includes the computing device 300 operating the browser application 122. The access point determiner 124 is also included in the system. The access point determiner 124 can be implemented and can be a part of the browser application, or can be implemented as a separate component form the browser application (as shown). The computing device 300 makes use of the communication mechanism 316 for communication with the cloud-based service 318. Those of skill in the art will appreciate that other known configurations can be utilized to implement the present invention, such that the present invention is by no means limited to the configuration shown.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

What is claimed is:

1. A computing device implemented browser system, comprising:
a browser application operating on the computing device and configured to receive user identifying information for a specified user and corresponding to a single user login;
an access point determiner operating on the computing device and configured to identify access point information;
a communication mechanism operating on the computing device enabling communication between the browser application and a cloud-based service;
two or more personalized browser display modes for the same user and user login capable of display by the browser application on the computing device;
wherein the cloud-based service, based at least on the user identifying information and the access point information, instructs the browser application to display a selected one of the two or more personalized browser display modes for the same user and user login.

2. The browser system of claim 1, wherein the access point information comprises one or more of device identification information, location information, or geolocation information.

3. The browser system of claim 2, wherein the location information comprises physical location, event based location, time based location, or any combination thereof.

4. The browser system of claim 1, wherein the access point information comprises user-identified mode information.

5. The browser system of claim 1, wherein the communication mechanism comprises a communication link between a device operating the browser application and the cloud-based service on a world wide web.

6. The browser system of claim 1, wherein the two or more personalized browser display modes comprise one or more of a home mode, an office mode, a travel mode, or a user customized mode.

7. The browser system of claim 1, wherein the two or more personalized browser display modes comprises a predetermined selection and arrangement of bookmark buttons.

8. The browser system of claim 1, wherein the two or more personalized browser display modes comprises a predetermined selection and arrangement of sub-windows, content of sub-windows, or both.

9. The browser system of claim 1, wherein the two or more personalized browser display modes are accessible by the user without requiring the user to activate more than one user login.

10. The browser system of claim 1, wherein the browser application has a synchronization feature enabling the browser application to synchronize its browser settings with the cloud-based service and with additional instances of the browser application on additional devices.

11. A method of implementing a browser system using a computing device, comprising:
a cloud-based service receiving automatically determined access point information from a browser application on the computing device; and
the cloud-based service instructing the browser application to display a selected one of two or more personalized browser display modes for a same user specific login based on the access point information.

12. The method of claim 11, further comprising the browser application displaying the selected one of two personalized browser display modes on the computing device.

13. The method of claim 11, wherein the access point information comprises one or more of device identification information, location information, or geolocation information.

14. The method of claim 13, wherein the location information comprises physical location, event based location, time based location, or any combination thereof.

15. The method of claim 11, wherein the two or more personalized browser display modes comprise one or more of a home mode, an office mode, a travel mode, or a user customized mode.

16. The method of claim 15, wherein each mode comprises a predetermined selection and arrangement of bookmark buttons, sub-windows, content of sub-windows, or combinations thereof.

17. The method of claim 11, wherein the two or more personalized browser display modes are accessible by the user without requiring the user to activate more than one user login.

18. The method of claim 11, further comprising the browser application synchronizing its browser settings with the cloud-based service and with additional instances of the browser application on additional devices.

19. A computing device implemented browser system, comprising:
a browser application operating on the computing device configured to receive user identifying information;
an access point determiner operating on the computing device configured to identify access point information;
a communication mechanism operating on the device enabling communication between the browser application and a cloud-based service;
at least two different personalized user profiles associated with a single user and user login;
wherein the cloud-based service, based at least on the user identifying information and the access point information, determines and instructs the browser application to implement a selected one of the at least two different personalized user profiles associated with the same user and user login.

20. The browser system of claim 19, wherein the access point information comprises one or more of device identification information, location information, or geolocation information.
